(19) United States
(12) Patent Application Publication
(10) Pub. No.: US 2022/0061366 A1
(43) Pub. Date: Mar. 3, 2022

(54) Honey substitute and methods of manufacture

(71) Applicant: Blake Edward Haner, Spokane, WA (US)

(72) Inventor: Blake Edward haner, Spokane, WA (US)

(73) Assignee: Blake Edward Haner, Spokane, WA (US)

(21) Appl. No.: 17/003,985

(22) Filed: Aug. 26, 2020

(51) Int. Cl. A23L 21/25; A23L 29/30; A23L 33/175; A23L 27/00; A23L 33/105; A23L 5/42; A23L 5/20

(52) U.S. Cl. CPC A23L 21/27; A23L 29/35; A23L 33/175; A23V 2002/00; A23L 33/105; A23L 5/42; A23L 5/21; A23L 27/88

(57) ABSTRACT

A method for manufacturing a honey substitute by dehydrating an acidic, aqueous mixture of sugars and gluconic acid to generate a supersaturated solution with selected viscosity at room temperature.

### TECHNICAL FIELD

This disclosure relates to vegan food alternatives. More specifically, the disclosure relates to the manufacture of honey substitutes.

### BACKGROUND

For the past several years, vegan alternatives to animal products have been increasingly popular with the American public. Products such as almond milk, plant-based burger patties, and even synthetic egg whites are now ubiquitous at homes and grocery stores. There are many new developments in this field, as animal-product alternatives continue to become more lifelike.

There are many reasons people choose a vegan diet, including ones that are moral, environmental, or health-related. Vegans abstain from animal products of any kind, including meat, dairy, and, most significantly to this disclosure, honey. This is because honey, as found in nature, is naturally produced by the honeybee, an animal. Honeybees in the commercial honey industry are often malnourished, mistreated, or even killed en-mass. Commercial honey operations can wipe out species of wild bees indigenous to their area, and make the entire honeybee population more susceptible to disease.

Products explicitly marketed as vegan honey alternatives have existed, most notably “Bee Free Honee.” Like other products of its kind on the market, it is made out of fruit, and has a questionable level of resemblance to honey. None of these products get very close to the flavor of natural honey, because they do not closely resemble natural honey on a chemical level. This has left the market for lifelike honey alternatives mostly unfilled, despite growing consumer demand for products of this kind.

### BRIEF SUMMARY

The present disclosure sets forth a honey substitute or “artificial honey” and methods of manufacturing the honey substitute. An example method produces the honey substitute or artificial honey by dehydrating a homogeneous, acidic mixture of water and sugars. The example method creates a honey substitute that bears a close resemblance to natural honey, making the honey substitute nearly indistinguishable in texture, flavor, and appearance from natural honey, from the standpoint of human consumers.

The disclosed method produces a honey substitute which has a number of advantages over honey substitutes currently on the market. In addition to having a lifelike flavor and similar physical properties to natural honey, the example honey substitute is inexpensive to manufacture, and has a formula that can be customized. The disclosed methods also solve problems outside the scope of vegan foods for humans; bee populations around the world are threatened by colony collapse disorder, and demand for honey substitutes increase when the price of honey increases because of these die-offs. Even if prices remain the same, the example honey substitute made by the example methods described herein can still be manufactured in bulk at lower prices than natural honey can be obtained. This makes the example honey substitute viable as a less expensive alternative to natural honey, especially in developing countries where honey can be too expensive for many people.

The perfect method for making honey already exists in nature, as executed by honeybees. To make honey, bees start by gathering flower nectar, which is about 80% water and contains sugars, aromatic volatiles, and other materials. They digest this in their honey stomach, which adds acid to the honey, and use enzymes to break the sucrose (sugar) present in nectar apart into levulose (fructose) and dextrose (glucose), the two largest components of honey. This process lowers the water content to approximately 40%, at which point the mass is regurgitated into a honeycomb. The bees fan air warmed by their bodies over the filled honeycomb with their wings, supersaturating the honey while lowering water content to approximately 17.8%.

The disclosed methods take inspiration from this natural process, making the honeybees' own techniques relevant as related art. The aim of developing the disclosed methods was to create an edible composition indistinguishable from honey, by recreating the conditions by which natural honey is made in nature. Many steps of the natural process were not included in some of the disclosed methods; for example, using enzymes to break sucrose down into levulose and dextrose is unnecessary because these two sugars can simply be started with. The core ideas of heating and dehydrating an acidified mixture of sugars, however, remain the same as might be implemented in nature.

The example honey substitute described herein is an acidic, supersaturated solution of sugars dissolved in water. The example honey substitute is made by using controlled evaporation and/or heating a mixture in a dehydrator to induce supersaturation in the homogeneous mixture; this results in a transformation of the homogeneous mixture into a transparent, viscous solution with the physical properties and flavor of honey. Because a supersaturated solution is involved, the honey substitute can exist as a solution despite containing too little water to dissolve its solutes under normal conditions.

In an embodiment, steps of an example method are as follows: preparing a homogeneous mixture, transferring the homogeneous mixture into a dehydrator, dehydrating the homogeneous mixture to induce supersaturation, and transferring the homogeneous mixture out of the dehydrator. This example method takes inspiration from the process that bees use to make honey in nature, and was developed by studying, simulating, and simplifying this natural process. A dehydrator is a machine that fans warm air over an object's surface, in order to lower its water content, for example.

There can be much variance in the composition of the honey substitute and the mixture it is derived from. However, the honey substitute and the mixture that it is derived from have a water content by mass of at least 15%, contain levulose, dextrose, and gluconic acid, have a pH of 6.25 or less, and in various implementations, never contain honey from bees.

### BRIEF DESCRIPTION OF THE DRAWINGS

FIG. 1 is a prior art table showing percentage composition by mass of a sampling of different honeys, from Moreira RFA, De Maria CAB (2001) Glicidos no mel. Quim Nova 24:516-525, via researchgate.net.

FIG. 2 is a table showing a percentage composition by mass of each component in an example composition of the mixture used to make the example honey substitute described herein.

FIG. 3 is a diagram depicting an example mixture being agitated in a blender, providing an example method of homogenizing the mixture.

FIG. 4 is a diagram depicting the example mixture being transferred from the blender into a pan, so that the pan can be placed inside a dehydrator, providing an example method of transferring the homogeneous mixture into the dehydrator.

FIG. 5 is a diagram depicting a pan containing the homogeneous mixture resting on a shelf inside of a shelf dehydrator, providing an example appearance of the homogeneous mixture shortly before dehydration.

FIG. 6 is a diagram of a pan containing the full of homogeneous mixture being dehydrated; the arrows depict warm air flowing over the top of the pan, and water evaporating out of the homogeneous mixture as a result.

FIG. 7 is a flow diagram of an example method of making a honey substitute.

### DETAILED DESCRIPTION

This disclosure describes honey substitutes, and methods of manufacture. In an implementation, the example honey substitute described herein is an acidic, supersaturated solution of sugars dissolved in water. The example honey substitute can be made by using controlled evaporation and heating a mixture in a dehydrator to induce supersaturation in the homogeneous mixture. The example process results in a transformation of the homogeneous mixture into a transparent, viscous solution with physical properties and flavor of honey. Because a supersaturated solution is involved, the honey substitute can exist as a solution despite containing too little water to dissolve its solutes under normal conditions.

In an embodiment, steps of an example method include preparing a homogeneous mixture, transferring the homogeneous mixture into a dehydrator, dehydrating the homogeneous mixture to induce supersaturation, and transferring the homogeneous mixture out of the dehydrator.

As used herein, the terms “natural honey” and “honey” refer to honey as found in nature, which is a sweet, viscous fluid produced by bees from nectar collected from flowers, and stored in nests or hives as food. As used herein, “honey substitute” refers to the products of the disclosed methods, which are sweet, viscous solutions that ideally have a high degree of resemblance to natural honey. As used herein, the terms “realistic” “realism” and “lifelike” refer to the degree of resemblance that the honey substitute has to natural honey. A “realistic” honey substitute is one with a very close or identical composition and/or flavor to natural honey as occurs in nature. As used herein, “component” refers to a constituent part or ingredient in a substance, system, process, or mixture. As used herein, “composition” refers to the honey substitute as recited in the patent claims and as shown and described in the specification and figures.

Example Methods

In step 1 of an example process, a mixture is prepared which contains all of the components that will be present in the example honey substitute, as well as additional water. The mixture at step 1 functions as a precursor to the example honey substitute, and is transformed into the example honey substitute through dehydration.

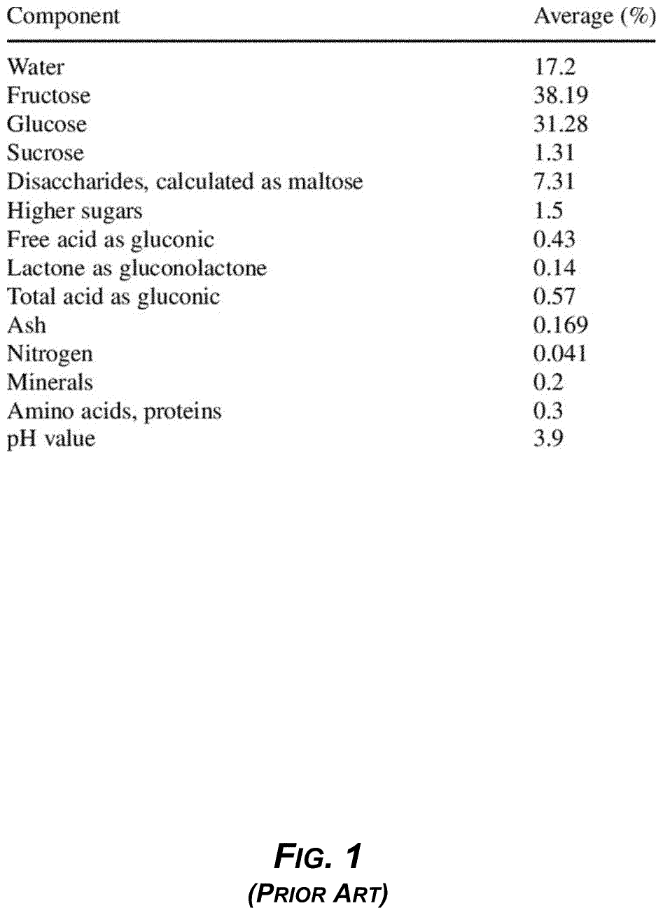

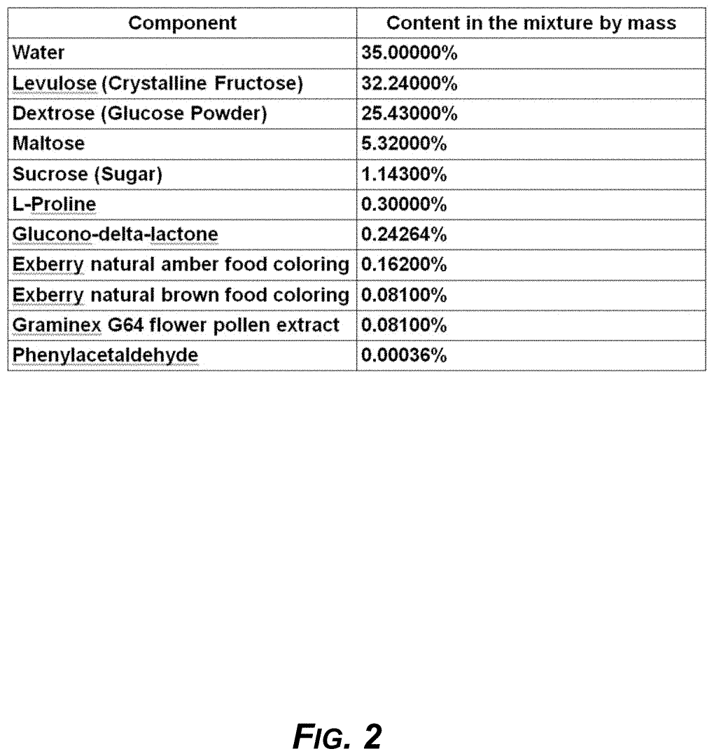

A flavor similar to natural honey is achieved in the example honey substitute by emulating natural honey's chemical composition in the mixture. Extra water, which is lost during dehydration, is added to the starting mixture to aid in achieving dissolution of solutes prior to supersaturation. FIG. 2 shows a composition of the example mixture which, through the example methods, yields a basic version of the example honey substitute. FIG. 1, for comparison, shows the percentage composition by mass of a sampling of conventional natural honeys, excluding some trace components. Components shown in FIG. 2 aim to emulate conventional components shown in FIG. 2, after adjusting for the extra water needed before supersaturation and simplifying for some aspects of the overall composition. The recipe shown in FIG. 2 has many of the non-water components of FIG. 1 present in similar proportions.

The composition of honey in nature varies substantially, and is dependent on many factors, such as floral origin, weather, and bee species. As such, there are technically numerous possible variations in the composition of the example mixtures of example honey substitute, just as there are numerous possible variations in the composition of honey in nature.

In example formulations of the honey substitute, the composition comprises an aqueous mixture of sugars with a pH of 6.25 or less. Water comprises at least 15% of the mixture's total mass in example embodiments. Sugars (defined as monosaccharide and disaccharide carbohydrates) comprise at least 75% of the mixture's non-water mass in example embodiments, with levulose and dextrose both being present, and together comprising at least 50% of the mixture's saccharide mass, in example embodiments. The starting mixture and examples of the honey substitute contain gluconic acid. In various implementation, the example honey substitute does not contain natural honey.

In an implementation, there are approximately six variables in the composition of the starting mixture that becomes the example honey substitute. For example, these components and features may vary: water content, relative ratios of sugars, acids, volatiles, and flavorings, and coloration. Additional components may also be added.

Water is the main substrate of the example mixtures, and the water functions as a medium for the non-water solute components of the example mixtures. Some water is lost from a given example mixture during a dehydration process, which is why the content of water is lower in the example honey substitute produced than in the starting mixture. Water functions as an aqueous solvent in the example honey substitute, which is a solution of its components, in water. The amount of water used in a starting mixture may not initially dissolve the non-water components of the mixture, because the example process of supersaturation has not proceeded yet. Supersaturation allows a liquid solvent to dissolve more of a solute than usual under normal saturation conditions for a given solute to be dissolved at a given temperature. The content of water in the starting mixture may vary between different example enumerations of the starting mixture, but in numerous implementations is kept at or above 15% of the mixture's total mass during processing. The example assay for the mixture shown in FIG. 2 has a water content of 35%, for example.

The content of water in the mixture must be high enough that the non-aqueous components can supersaturate while dissolving into the water during dehydration, or in some implementations, during cooling. In an implementation, the lower the water content in the starting mixture, the less time it takes to reach a desired water content of the example honey substitute, which is approximately 17% by mass, achieved during dehydration and/or cooling. The ratio of 17% is given as a preferred water content for the example honey substitute because this percentage is close to the average natural water content of natural honey, which is approximately 17.8%, yet is slightly more viscous than natural honey because of the lower water content, so its texture is more honey-like, according to most human consumers' conception of natural honey.

Sugars, defined here as monosaccharide and disaccharide carbohydrates, comprise at least 75% of the mixture's non-water mass in various example implementations, and are the primary dry starting ingredient in the components for the starting mixtures. Natural honey is a complex mix of different sugars, with levulose and dextrose comprising the bulk of its mass, and this is reflected in the composition of the mixture as shown in FIG. 1. In the example honey substitutes, levulose (also known as fructose) and dextrose (glucose) usually comprise at least 50% the mixture's sugar mass, and are essential to recreating the flavor of natural honey. Maltose and sucrose are also common in natural honey, and can be included in the example starting mixtures for a more lifelike flavor. Other, more complex sugars than these occur in honey, but make up only a small percentage of its total mass. These can optionally be included in the example starting mixtures, however. See FIG. 2 for an example composition of the mixture that includes sugar percentages. The ratio of different sugars to each other will have an effect on the flavor of the example honey substitute. For example, levulose is sweeter than dextrose, so increasing the ratio of levulose to dextrose in the example mixtures increases the sweetness of the resulting honey substitute.

Just like natural honey, the example mixtures for making the example honey substitute are acidic, having a pH of 6.25 or less. The pH of natural honey is variable, ranging from 3.4 to 6.1, with an average pH of 3.9. The acidity of the example honey substitute is increased through the addition of food-safe acids, for example, gluconic acid, to the example mixtures. These acids are preferably the same acids that are found in natural honey, to improve the honey substitute's realism, but other acids may also be used. Gluconic acid is the most common acid in honey by a wide margin, with citric acid, formic acid, and acetic acid also commonly occurring at substantial levels. Gluconic acid greatly contributes to the realism of the honey substitute's flavor, and is included in many enumerations of the components for the starting mixtures. Gluconic acid can be added to the mixture in the form of glucono-delta-lactone, which hydrolyzes into gluconic acid in the example mixtures.

In some implementations of the example starting mixture, aromatic volatile compounds or other flavorings are added to the example mixtures to give them a more lifelike flavor. Aromatic volatiles occur in natural honey, and create the flavor profiles associated with the many varietals of honey that bees produce, such as clover honey, acacia honey, and blackberry honey. Aromatic volatiles can be used to create a general honey flavor, through inclusion in the example mixtures of the volatiles commonly found in most honey varietals, such as ethanol, acetic acid, phenylacetaldehyde, and others. Phenylacetaldehyde has a distinctly honey-like flavor, and is the only token volatile or flavoring used in the example composition of the example starting mixture shown in FIG. 2. Aromatic volatiles can also be used to tailor the flavor of the example honey substitute to match the flavor of a natural honey varietal, through inclusion in the mixture of volatiles specifically found in certain honey varietals. Studies that break down and compare the volatile compositions of certain honey varietals can be used as references for attempting to recreate these varietals.

In some implementations of the example starting mixtures, coloring is added to a given mixture in order to give the example honey substitute a more honey-like appearance, or for other aesthetic purposes. The color of honey in nature ranges from dark brown to pale yellow, but is usually a shade of amber. Amber coloration can be induced in the example honey substitute through a combination of brown and yellow food coloring added to the mixture. The example composition of the mixture in FIG. 2 contains natural amber and brown colorings from Exberry (GNT Group, Mierlo, Netherlands). Colors different from those of natural honey may be added to the example mixtures to create an example honey substitute with novel coloration.

In some implementations of the example mixtures, components that do not qualify as water, a sugar, an acid, an aromatic volatile or flavoring, can be added to the example mixtures. These components may include, but are not limited to: flower pollen, amino acids, trace minerals, cannabidiol or other cannabinoids, vitamins, and artificial sweeteners. These may be added for reasons such as realism of the example honey substitute, nutritional value, and consumer expectations. The example composition of the mixture shown in FIG. 2 includes flower pollen extract, as well as L-Proline, a common amino acid in natural honey. These have been included as example additives in order to improve the flavor and realism of the example honey substitute.

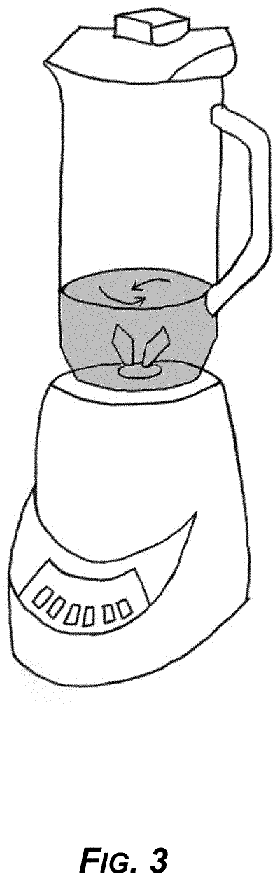

In an implementation, an example process proceeds with a homogeneous mixture, meaning that the example mixture has been homogenized to same proportions of its components throughout any given section of the example mixture. Preferably, there are no variations of components throughout the mixture, or any phases visible within the homogenized mixture. Homogenization can be performed by blender, but can also be accomplished through other methods and devices. FIG. 3 shows a depiction of an example mixture being homogenized in a blender. Homogeneity of the mixture can sometimes be improved by heating an example mixture during homogenization, because solubility generally increases with temperature, causing the sugars, for example, to more thoroughly dissolve into and mix with the water component, and many blenders generate heat during blending.

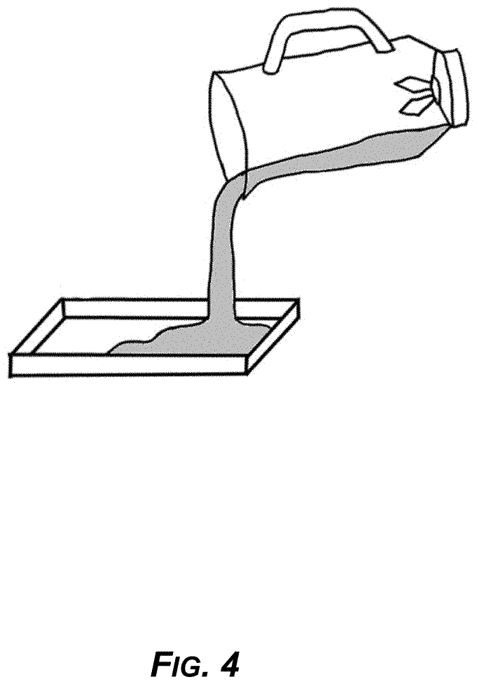

In an example second step of the example process, the homogeneous mixture is transferred into a dehydrator, with some portion of the homogeneous mixture exposed to air or an ambient environment within or by the dehydrator. A dehydrator is defined here as a device used to decrease the water content of a mixture by blowing warm air over the mixture, in order to facilitate water removal through evaporation. In most implementations of the example methods, the transfer into the dehydrator is accomplished by pouring the homogeneous mixture into a wide, shallow, open-topped container, as shown in FIG. 4, and then transferring this container of the mixture onto a shelf in the dehydrator, for example.

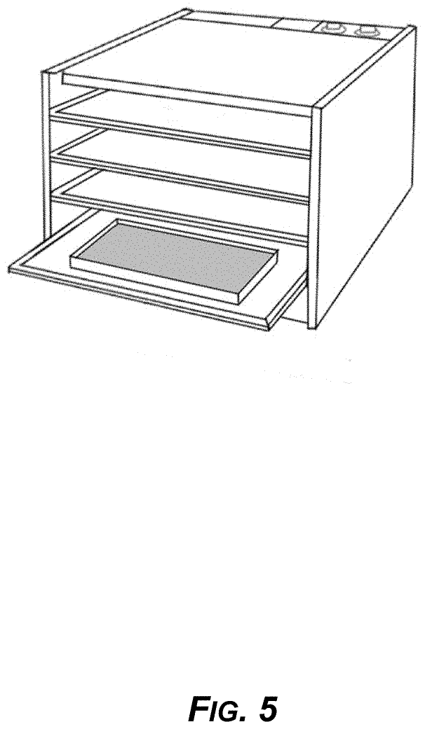

FIG. 5 shows a container of an example homogeneous mixture resting on a shelf inside of a dehydrator. A container used in the dehydrator should give the homogeneous mixture a high ratio of exposed surface area to volume. This means the container is preferably wide and shallow, to maximize exposed surface area for a given volume of the example mixture. A sheet, pan or tray works well for this purpose. A high ratio of exposed surface area to volume maximizes the amount of homogeneous mixture exposed to warm, fanned air during a given time interval of dehydration, causing the homogeneous mixture to dehydrate faster by encouraging evaporation over a greater surface area.

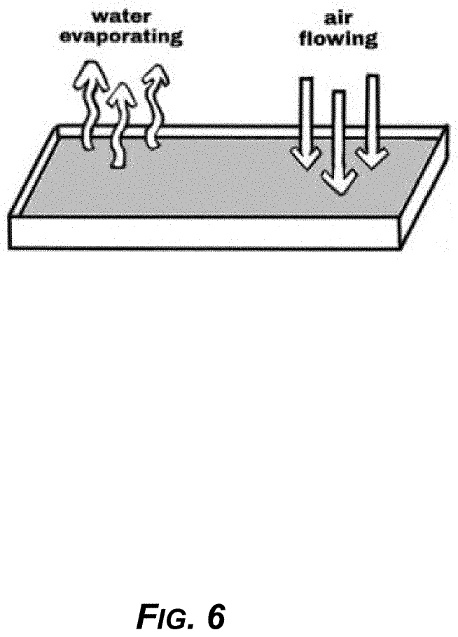

In an example third step of the example process, the homogeneous mixture is dehydrated, through methods involving the use of warm air blown over its surface, until the homogeneous mixture becomes a supersaturated solution, and reaches the target water content of approximately 17%. Some implementations also add cooling of the mixture to achieve a state of supersaturation. The percentage of water in the example honey substitute can range from 7.5% to 25% of the total mass of the example mixture. In an implementation, two variables in the dehydration process are temperature and time. Dehydration transforms the homogeneous mixture into the example honey substitute, because it transforms a homogeneous mixture into a stable supersaturated solution. FIG. 6 shows the process of dehydration, with warm air fanned over an exposed surface of the mixture in a container, and water evaporating out of the example mixture as a result.

Most dehydrators allow a user to set the temperature of the air to be fanned for dehydration. In an implementation, the dehydrator is set to a temperature of no greater than 109° C., because fructose caramelizes at 110° C., which can possibly cause the fructose to denature in some circumstances, including darkening and taking on an undesirable, burnt flavor around edges, for example. Most dehydrators have a maximum temperature lower than 109° C., however. The temperature should also be lower than the flash point of any aromatic volatile compounds in the homogeneous mixture, and the temperature should not destabilize or otherwise have an adverse impact on any components of the homogeneous mixture. A typical temperature for dehydrating the homogeneous mixture is 73.5° C.; this temperature is safe to use with the example composition of the mixture shown in FIG. 2.

In an implementation, a low temperature dehydrator achieves the example honey substitute from the starting mixture by dehumidification. By conditioning the air in a chamber, the dehumidifier removes moisture from the chamber and from the mixture being dehydrated into the example honey substitute. The dehumidifier may also lower the temperature of the homogenous mixture to force supersaturation at a lower point on a temperature-solubility curve for at least one of the components in the example mixture.

The amount of dehydration time to achieve a water content of 17% (or other water-content figure within the given parameters) varies depending on the composition of the example mixture, the temperature used, and the manner in which the homogeneous mixture is transferred into the dehydrator or dehumidifier. When a container of the mixture is used for transferring the homogeneous mixture into and out of the dehydrator or dehumidifier, this amount of time can be determined experimentally by measuring the weight of a given container of the mixture before dehydration, then measuring it again at regular time intervals as it dehydrates. Because loss of mass during dehydration corresponds to loss of water, the change in mass at each interval from the starting mass of the mixture can be subtracted from the starting mass of water in the mixture to determine the mass of water at that interval. To determine the percentage content of water at an interval, divide 100% by the total mass of the mixture at that interval, then multiply the resulting percentage by the mass of water at that interval. When an amount of time that yields a target water percentage is found, this same amount of time can be used to yield the same approximate water percentage, as long as no variables are changed. If any variables are changed, the process can be repeated. With one example dehydrator, an example mixture with the example composition shown in FIG. 2 takes approximately three and a half hours to dehydrate sufficiently at 73.5° C., depending on the geometry of the pan.

Inducing supersaturation in the example mixture is the goal of dehydrating the homogeneous mixture to achieve the preferred water percentage, instead of simply starting with that percentage. Supersaturation is a process by which more of a solute can be dissolved in a solvent than would normally be predicted by the solubility of that solute. Natural honey is a supersaturated solution, which is why natural honey can exist as an aqueous solution of sugars, despite having a water content of 20% or lower. The example honey substitute is preferably a supersaturated solution, because it is transformed during dehydration from a homogeneous mixture that is near saturation to a supersaturated solution. Supersaturation in the case of the example methods is accomplished through the double action of temperature dependence versus solubility of each solute with respect to water, and the reduction of volume or mass of the water solvent itself through evaporation to increase the concentration of the solutes in solution in the water. Cooling may also be used sometimes as an adjunct to achieve the supersaturated state of the example honey substitute. Heating the homogeneous mixture inside a dehydrator can increase the solubility of the component sugars, allowing the mixture to become an aqueous solution, with all or most components dissolved, before becoming a supersaturated solution. Reducing the volume of water as solvent in the foregoing saturated solution through evaporation leads to an increased concentration of the solutes, without affecting the dispersed state of the solutes in the solution. Concentration through evaporation, in conjunction with mild heating, may be the primary mechanism used by honeybees to supersaturate their honey.

In an example fourth step of the example method, after reaching a water concentration of approximately 17%, or another target water content ranging from 7.5% to 25%, and being transformed to a supersaturated solution, the example honey substitute is transferred out of the dehydrator. The honey substitute may slightly contract as it cools, and also become more viscous.

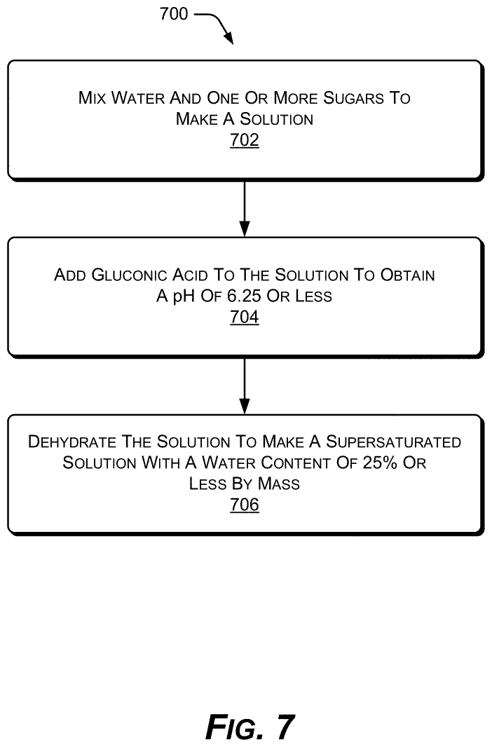

FIG. 7 shows an example method 700 of making a honey substitute.

At block 702, one or more sugars are mixed with water to make a solution.

At block 704, gluconic acid is added to the solution to obtain a pH of 6.25 or less.

At block 706, the solution is dehydrated to make a supersaturated solution with a water content of 25% or less by mass.

The dehydrated supersaturated solution preferably has a viscosity of at least 10,000 centipoise at a temperature of 20° C.

1. A honey substitute, comprising:
water;
one or more sugars dissolved in the water to provide a supersaturated solution of the one or more sugars in the water;
gluconic acid to provide a pH of 6.25 or less; and
wherein an amount of the water provides a viscosity of at least 10,000 centipoise at a temperature of approximately 20° C.

2. The honey substitute of claim 1, wherein the one or more sugars comprise at least 50% by mass of a total non-water mass of the honey substitute.

3. The honey substitute of claim 1, wherein the water comprises between 7.5-25.0% by mass of the total mass of the honey substitute.

4. The honey substitute of claim 3, wherein the water comprises 17% by mass of the total mass of the honey substitute.

5. The honey substitute of claim 1, wherein the one or more sugars comprise levulose and dextrose.

6. The honey substitute of claim 1, wherein the supersaturated solution comprises 5.0-25.0% water by mass;
wherein approximately 75% by mass of a non-water mass of the honey substitute comprises sugars; and
wherein at least 50% by mass of the sugars comprise levulose and dextrose.

4. A method for making a honey substitute, comprising:
preparing or acquiring a homogeneous mixture, with a composition by total mass of no less than 15% water, a composition by non-water mass of no less than 50% sugars, a composition by sugar mass of no less than 50% levulose and dextrose, possessing a ph of 6.25 or less, containing gluconic acid or glucono-delta-lactone, levulose, and dextrose, and not containing any bee-derived honey;
transferring said homogeneous mixture into a dehydrator, in a manner which leaves some portion of the homogeneous mixture exposed to air within the dehydrator; dehydrating the homogeneous mixture using the dehydrator, which blows warm air over the surface of the homogeneous mixture to facilitate evaporation, thus inducing supersaturation, whereby the homogeneous mixture transforming into a supersaturated solution;
transferring the supersaturated solution out of the dehydrator after it has a water composition by total mass of no more than 25%, no less than 7.5%, and a lower water content than when it was transferred into the dehydrator as the homogeneous mixture.

5. The method of claim 4, wherein the homogeneous mixture is prepared within the dehydrator, and therefore not transferred into the dehydrator after being prepared or acquired.

6. The method of claim 4, wherein the homogeneous mixture is transferred out of the dehydrator before reaching a water composition by total mass of 25%, then transferred back into the dehydrator until either: the homogeneous mixture reaches a water composition by total mass of 25%, or the homogeneous mixture is removed from the dehydrator before reaching a water composition by total mass of 25% and transferred back into the dehydrator again.

7. A method, comprising:
mixing water and one or more sugars to make a solution;
adding gluconic acid or glucono-delta-lactone to the solution to obtain a pH of 6.25 or less;
dehydrating the solution to make a supersaturated solution with a water content of 25% or less by mass.

8. The method of claim 7, wherein the supersaturated solution has a viscosity of at least 10,000 centipoise at a temperature of approximately 20° C.

9. The method of claim 7, wherein the one or more sugars comprise levulose and dextrose.

10. The method of claim 7, further comprising mixing components to make the solution, the components comprising:
the water comprising 35.00000% by mass;
levulose comprising 32.24000% by mass;
dextrose comprising 26.43000% by mass;
maltose comprising 5.32000% by mass;
sucrose comprising 1.14300% by mass;
L-proline comprising 0.30000% by mass;
glucono-delta-lactone comprising 0.24264% by mass;
amber food coloring comprising 0.16200% by mass;
brown food coloring comprising 0.08100% by mass;
flower pollen extract comprising 0.08100% by mass; and
phenylacetaldehyde comprising 0.00036% by mass.

11. The method of claim 10, wherein the step of dehydrating the solution to make the supersaturated solution reduces the water content to 17% by mass.
